(19) United States
(12) Patent Application Publication
(10) Pub. No.: US 2017/0189859 A1
(43) Pub. Date: Jul. 6, 2017

(54) ZEOLITE ENHANCED CARBON MOLECULAR SIEVE MEMBRANE

(71) Applicant: L'Air Liquide, Societe Anonyme pour l'Etude et I'Exploitation des Procedes Georges Claude, Houston, TX (US)

(72) Inventors: Yudong CHEN, Garnett Valley, PA (US); Madhava KOSURI, Newark, DE (US); Edgar S. SANDERS, Newark, DE (US); Dean W. KRATZER, Warwick, MD (US)

(21) Appl. No.: 14/985,772

(22) Filed: Dec. 31, 2015

(51) Int. Cl. B01D 67/00; B01J 20/18; B01D 69/08; B01J 20/30; B01D 71/02; B01J 20/20; B01J 20/28

(52) U.S. Cl. CPC B01D 67/0067; B01J 20/20; B01J 20/18; B01J 20/28033; B01J 20/3078; B01D 71/028; B01D 69/08

(57) ABSTRACT

A zeolite enhanced carbon molecular sieve (CMS) membrane is made by forming a precursor membrane from a matrix of polymer and zeolite particles and pyrolyzing the precursor membrane.

### CROSS-REFERENCE TO RELATED APPLICATIONS

None.

### BACKGROUND

Field of the Invention

The present invention relates to carbon molecular sieve membranes and gas separations utilizing the same.

Related Art

Membranes are viewed as selective barriers between two phases. Due to the random thermal fluctuations within the polymer matrix, gas molecules from the high partial pressure side sorb into the membrane and diffuse through under the influence of a chemical potential gradient, and finally desorb to the low partial pressure side. Two terms, “permeability” and “selectivity”, are used to describe the most important properties of membranes-productivity and separation efficiency respectively. Permeability (P) equals the pressure and thickness normalized flux, as shown in the following equation:

$${P}_{i} = \frac{{n}_{i} \cdot l}{Δ {p}_{i}} \qquad ( 1 )$$

where nᵢ, is the penetrant flux through the membrane of thickness (I) under a partial pressure (Δpᵢ).The most frequently used unit for permeability, Barrer, is defined as below:

$$Barrer = {10}^{10} \frac{{cm}^{3} ( STP ) \cdot cm}{{cm}^{2} \cdot s \cdot cmHg} \qquad ( 2 )$$

Selectivity is a measure of the ability of one gas to flow through the membrane over that of another gas. When the downstream pressure is negligible, the ideal selectivity (based upon the permeabilities of pure gases) of the membrane, can be used to approximate the real selectivity (based upon the permeabilities of the gases in a gas mixture). In this case, the selectivity (α_{A/B}) is the permeability of a first gas A divided by the permeability of a second gas B.

Currently, polymeric membranes are well studied and widely available for gaseous separations due to easy processability and low cost. In particular, polyimides have high glass transition temperatures, are easy to process, and have one of the highest separation performance properties among other polymeric membranes. The patent literature (including US 2011/138852; U.S. Pat. No. 5,618,334; U.S. Pat. No. 5,928,410; and U.S. Pat. No. 4,981,497) discloses one particular class of polyimides for use in polymeric gas separation membranes that is based upon the reaction of a diamine(s) with 2,2-bis (3,4-dicarboxyphenyl) hexafluoropropane dianhydride (6FDA).

Interest in the development of porous inorganic membranes has grown recently due to fact that inorganic membranes provide better selectivity and thermal and chemical stabilities than polymeric membranes. The attention has focused on materials which exhibit molecular sieving properties, like zeolite and carbon. These materials have been widely used in many gas separation processes as in shape of individual particles by using pressure swing adsorption or thermal swing adsorption technique. Gas separation by membranes offers many advantages due to its small footprint, steady-state process, easy to operate and high throughput.

Synthetic zeolite is a well known inorganic sorbent. It is usually synthesized under hydrothermal condition from solutions of sodium aluminate, sodium silicate, or sodium hydroxide. The precise zeolite formed is determined by the reactants used and the synthesis conditions, such as temperature, time, and pH used. It is a crystalline material having a large pore volume and surface area, and more importantly, pores of uniform size. Unfortunately, it is still a challenge to obtain large single zeolite crystals or zeolite fibers which can be used as membrane separation. In practical applications, zeolites are usually in a granular form made by gluing the zeolite crystals particles with binder. In the latest development of binder less zeolite, the binder material is also converted to the porous material for gas separation.

On the other hand, structured adsorbent materials have become an attractive alternative for use in gas separation processes. The structured adsorbent bed technology brings many advantages to the gas separation processes, such increasing overall mass and heat transfer rates, overcoming bed fluidization problems. It also has a compact design. A gas separation module incorporating a structured adsorbent material can be made from a variety of different techniques. For example, a structured adsorbent wheel has been made from zeolite paper prepared from a natural or synthetic fiber material. This fiber material is then combined with the zeolite and wet-laid into a continuous sheet or handsheet. This wet-laying is achieved by forming slurry of the fiber, the zeolite and binder components in water. This slurry is then transferred to a handsheet mold or a continuous wire paper machine for introduction onto the papermaking process.

Carbon molecular sieve (CMS) membranes have been successfully prepared by the pyrolysis of synthetic precursors under controlled pyrolysis conditions. These polymer precursors include polyfurfuryl alcohol, kapton-type polyimide, 6F-containing polyimide copolymer and other cellulose and derivatives, thermosetting polymers, and peach tar mesophase. The newly prepared CMS membranes have shown attractive gas separation properties. For example, the CO₂/CH₄ selectivity in some CMS membranes is higher than 50 with a CO₂ permeability of nearly 3000 Barrer.

CMS membranes are typically produced through thermal pyrolysis of polymer precursors. For example, it is known that defect-free hollow fiber CMS membranes can be produced by pyrolyzing cellulose hollow fibers (J. E. Koresh and A. Soffer, Molecular sieve permselective membrane. Part I. Presentation of a new device for gas mixture separation. Separation Science and Technology, 18, 8 (1983)). In addition, many other polymers have been used to produce CMS membranes in fiber and dense film form, among which polyimides have been favored.

CMS membranes have also been produced from a wide variety of 6FDA-based polyimide precursors including the following specific examples.

Shao, et al. disclosed that gas separation performance of CMS membranes (films) pyrolyzed from different morphological precursors is strongly dependent on pyrolysis temperature (Shao, et al., Journal of Membrane Science 244 (2004) 77-87). The tested CMS membranes included those based upon 6FDA/PMDA-TMMDA and 6FDA-TMMDA, where PMDA is pyromellitic dianhydride, and TMMDA is tetramethylmethylenedianiline.

Low, et al. disclosed CMS membranes (films) pyrolized from pseudo-interpenetrating networks formed from 6FDA-TMPDA polyimide and azide, where TMPDA is 2,3,5,6-Tetramethyl-1,4-phenylenediamine (Low, et al., Carbon molecular sieve membranes derived from pseudo-interpenetrating polymer networks for gas separation and carbon capture, Carbon 49 (2011) 2104-2112).

Swaidan, et al. disclosed the study of CH₄/CO₂ separations using thermally rearranged membranes and CMS membranes (films) pyrolized from polyimides based upon 6FDA and 3,3,3′,3′-tetramethyl-1,1′-spirobisindane-5,5′-diamino-6,6′-diol (Swaidan, et al., available online, accepted for publication on Jul. 28, 2013).

Kiyono, et al. disclosed the effect of pyrolysis atmosphere upon the performance of CMS membranes (films) pyrolyzed from 6FDA/BPDA-DAM, where DAM is 2,4,6-trimethyl-1,3-phenylene diamine and BPDA is 3,3,4,4-biphenyl tetracarboxylic dianhydride (Kiyono, et al., Effect of pyrolysis atmosphere on separation performance of carbon molecular sieve membranes, Journal of Membrane Science 359 (2010) 2-10).

Xu, et al. disclosed CMS membranes (hollow fibers) pyrolyzed from polyimides based upon BTDA-DAPI (Matrimid® 5218), 6FDA-DAM, and 6FDA/BPDA-DAM, where BTDA is 3,3′,4,4′-benzophenone tetracarboxylic dianhydride, DAPI is diaminophenylindane, DAM is 2,4,6-trimethyl-1,3-phenylene diamine. and BPDA is 3,3,4,4-biphenyl tetracarboxylic dianhydride (Xu, et al., Olefins-selective asymmetric carbon molecular sieve hollow fiber membranes for hybrid membrane-distillation processes for olefin/paraffin separations, Journal of Membrane Science 423-424 (2012) 314-323).

Fuertes, et al. disclosed the preparation and characterization of CMS membranes (films) pyrolyzed from Matrimid® and Kapton®, where Kapton® is a polyimide based upon pyromellitic dianhydride and 4,4′-oxydiphenylamine (Fuertes, et al., Carbon composite membranes from Matrimid® and Kapton® polyimides for gas separation, Microporous and Mesoporous Materials 33 (1999) 115-125).

Tin, et al. studied the permeation of CO₂ and CH₄ with CMS membranes (films) pyrolyzed from P84 polyimide based BTDA-TDI/MDI, where tetracarboxylic dianhydride and MDI is 80% methylphenylene-diamine +20% methylene diamine (Tin, et al., Separation of CO₂/CH₄ through carbon molecular sieve membranes derived from P84 polyimide, Carbon 42 (2004) 3123-3131).

Park, et al. studied the effect of different numbers of methyl substituent groups on block copolymides (PI-X) used to formulate CMS membranes (films). The block copolymides included those based upon BTDA-ODA/m-PDA, BTDA-ODA/2,4-DAT, and BTDA-ODA/m-TMPD, where ODA is 4,4-oxydianiline, m-PDA is 1,3-Phenylenediamine and 2,4-DAT is 2,4-diaminotoluene (Park, et al., Relationship between chemical structure of aromatic polyimides and gas permeation properties of their carbon molecular sieve membranes, Journal of Membrane Science 229 (2004) 117-127).

Hosseini, et al. compared the performance of CMS membranes pyrolyzed from each of Torlon (a polyamide-imide), P84, or Matrimid alone, and also in binary blends with polybenzimidazole (PIB), where Torlon (Hosseini, et al., Carbon membranes from blends of PBI and polyimides for N₂/CH₄ and CO₂/CH₄ separation and hydrogen purification, Journal of Membrane Science 328 (2009) 174-185).

Yoshino, et al. disclosed the separation of olefins/paraffins using a CMS membrane (hollow fiber) pyrolyzed from a polyimide based upon 6FDA/BPDA-DDBT, where DDBT is 3,7-diamino-2,8(6)-dimethyldibenzothiophene sulfone (Yoshino, et al., Olefin/paraffin separation performance of carbonized membranes derived from an asymmetric hollow fiber membrane of 6FDA/BPDA-DDBT copolyimide, Journal of Membrane Science 215 (2003) 169-183).

The use of mixed matrix membranes, made up of a mixed matrix of CMS material and polymer, have been proposed for use in gas separation.

U.S. Pat. No. 6,585,802 discloses the preparation of such a mixed matrix membrane by dispersing CMS carbon particles in a polymer solution followed by evaporation of the solvent to form the final membrane. The CMS carbon particles in their study were formed by pyrolyzing specific polymer precursors and then crushed to a fine powder before being mixed with the polymer solution.

US 2007/0017861 discloses a process for preparing a nanocomposite membrane which comprises a nanoporous carbon matrix comprising a pyrolyzed polymer and a plurality of nanoparticles of carbon or an inorganic compound disposed in the matrix. In the patent, the pyrolysis is carried out in a non-oxidizing atmosphere, such as argon, nitrogen, carbon dioxide or some other inert gases purge. A multiple coating technical was used in the process to ensure the desired O2/N2 selectivity. An improvement of the O2 and N2 permeance was claimed.

Zeolite materials (particles) have been widely used in many industrial gas separation applications by pressure swing adsorption (PSA) or thermal swing adsorption (TSA) techniques due to their higher gas selectivity and adsorption capacity. More specifically, the zeolite adsorbent offers a better adsorption capacity for CO₂ at certain pressure range compared to CMS materials. Therefore, a membrane made from zeolite can potentially increase CO₂ selectivity from CO₂/CH₄ or CO₂/H₂ due to higher CO₂ surface flux through a zeolite material. Unfortunately, it is challenge to obtain a large single zeolite crystals or zeolite fibers which can be used as zeolitic membrane.

While polymer/zeolite mixed matrix membranes have been proposed, forming membranes with satisfactory properties remains a challenge. The polymer membrane normally consists of polymer substrate material (large pore) and active thin polymer film. The thinner the active polymer film, the better the gas flux through the membrane. The thickness of the active film is normally in the order of micro meter, which is in the same range of zeolite crystal size. As a result, it is very difficult to completely seal off the zeolite in the coated thin polymer film for polymer/zeolite mixed matrix membranes. Hence gas flow channeling and leakage through the active polymer film seems inevitable.

### SUMMARY

There is disclosed a method for producing a carbon molecular sieve (CMS) membrane that includes the following steps.

### DESCRIPTION OF PREFERRED EMBODIMENTS

The CMS membranes of the invention are believed to be capable of relatively high permeabilities and selectivities in various gas separations, including CO₂/CH₄, O₂/N₂, and C₃H₆/C₃H₈. The CMS membranes of the invention are made up of a mixed matrix of carbon molecular sieve (CMS) and zeolite material, which is made from CMS/zeolite fiber or discs. This proposed zeolite enhanced CMS membrane possesses both the advantages of zeolites and CMS materials. It further improves the membrane separation selectivity and permeability, therefore, reduces membrane operational cost in gas separation applications. Unlike some conventional mixed matrix membranes, the CMS membranes of the invention are not prepared by formation of a membrane from a mixture of CMS particles, zeolite particles, and polymer. Rather, the CMS membranes of the invention are prepared by forming an intermediate mixed matrix membrane of zeolite particles in a polymer and subsequently pyrolyzing the formed matrix membrane so that the polymer is pyrolyzed into a CMS material.

We also propose a technique for avoiding deactivation of the zeolite particles during preparation of the inventive membrane. Polymer decomposition during high temperature pyrolysis generates reaction by-products, which contain normally hydrocarbons. These hydrocarbon by-products tend to adsorb onto the zeolite pore when zeolite crystal or powder is present in the polymer precursors. The hydrocarbon adsorption on the zeolite can take place even under an inert gas purge environment (where the hydrocarbon partial pressure in the gas phase is negligible) during pyrolysis due to the high chemical potential on the zeolite surface. We believe that the adsorbed hydrocarbons inside the zeolite pores are converted to dense carbon material under the pyrolysis conditions. It is further believed that this dense carbon material will ultimately block the zeolite pores and deactive the zeolite so that its gas separation function is nullified.

The above-described problem is solved by subjecting the membrane undergoing pyrolysis to an inert gas purge and/or vacuum.

As discussed, zeolite pore blocking and deactivation may occur through adsorption of by-products during thermal pyrolysis process. The hydrocarbon by-products may be removed from the “green membrane” being pyrolyzed by purging the pyrolysis atmosphere with an inert gas. The inert gas purge creates a concentration driving force (a concentration gradient) between the adsorbed phase (on/in the membrane undergoing pyrolysis) and the gas phase so that the hydrocarbon molecules may diffuse out from the membrane undergoing pyrolysis. Therefore, the dense carbon deposition on the CMS porous matrix can be eliminated if the diffusion rate is faster than the carbon deposition reaction rate In general, high inert gas purge is preferred if pyrolysis temperature or temperature ramping rate is high.

The use of a high degree of vacuum during pyrolysis can also help to force the hydrocarbon by-products from the pores in the membrane undergoing pyrolysis. This mechanical driving force overcomes the zeolite surface affinity for the hydrocarbon molecules. Therefore it prevents carbon deposition on the zeolite and CMS porous matrix.

Any polymer known in the field of CMS membranes may be used in the invention for admixture with the zeolite particles. Suitable polymers include: polyimides, polyamides, polyimide amides, polyacrylonitrile (PAN), phenolic resin, polyfurfuryl alcohol (PFA), polyvinylidene chloride-acrylate terpolymer (PVDC-AC), phenol formaldehyde, cellulose and derivatives (such as cellulose acetate), and peach tar mesophase. Similarly, any zeolite known in the field of gas separation may be used in the invention for admixture with the polymer prior to pyrolysis. particles are similarly not limited in the invention. Any The CMS membrane is made by pyrolyzing a polyimide polymer or copolymer

While the membrane may have any configuration known in the field of gas separation, typically it is formed as a flat film or as a plurality of hollow fibers. In either case and before formation of the precursor membrane, the polyimide is optionally dried and later dissolved in a suitable solvent to provide a precursor solution.

The drying may be carried out in, for example, a drying vacuum oven, typically at a temperature ranging from 110-150° C. for at least 6 hours (and as much as 6-12 hours). Drying is considered to be completed once a steady weight is achieved. Other known methods of drying such as heating in an inert gas purge may additionally or alternatively be employed.

Dissolution in, and homogenous distribution of, the polyimide in the solvent may be enhanced by mixing with any known mixing device, including rollers, stirrer bars, and impellers. In the case of dense films, a mixing time of at least 6 hours or as much as 6-24 hours will help to achieve homogeneity, which may help to reduce or eliminate defects in the precursor membrane. In the case of a hollow fiber precursor membrane, the precursor solution may be mixed for a longer period of time, such as 6 hours to 30 days (optionally 3-10 days or even 3-7 days).

The concentration of the polymer in the precursor solution is typically driven by the configuration of the precursor polymeric membrane. For example, a concentration ranging from 2-20 wt % (or optionally from 3-15 wt % or even 3-5 wt %) by weight of the precursor solution is suitable for formation of dense films. On the other hand, a concentration ranging from 15-35 wt % (or optionally 18-30 wt % or even 22-28 wt %) is suitable for spinning hollow fibers.

Suitable solvents may include, for example, dichloromethane, tetrahydrofuran (THF), N-methyl-2-pyrrolidone (NMP), and others in which the resin is substantially soluble, and combinations thereof. For purposes herein, “substantially soluble” means that at least 98 wt % of the polymer in the solution is solubilized in the solvent. Typical solvents include N-methylpyrrolidone (NMP), N,N-dimethylacetamide (DMAC), N,N-dimethylformamide (DMF), dimethyl sulfoxide (DMSO), gamma-butyrolactone (BLO), dichloromethane, THF, glycol ethers or esters, and mixtures thereof.

In order to prepare a precursor membrane configured as a dense film, any suitable method of film preparation, such as solution casting, may be employed. A typical solution casting method employs knife casting where the polymer solution is coated on a travelling support web at a thickness set by the gap between the knife edge and the web below. The resulting polymer solution film is passed through an air gap and immersed in a suitable liquid coagulant bath to facilitate phase inversion of the dissolved polyimide and solidification of the precursor membrane structure.

In the case of a precursor membrane configured as hollow fibers, the hollow fibers may be spun by any conventional method. A typical procedure for producing hollow fibers of this invention can be broadly outlined as follows. A bore fluid is fed through an inner annular channel of spinneret designed to form a cylindrical fluid stream positioned concentrically within the fibers during extrusion of the fibers. A number of different designs for hollow fiber extrusion spinnerets known in the art may be used. Suitable embodiments of hollow-fiber spinneret designs are disclosed in U.S. Pat. No. 4,127,625 and U.S. Pat. No. 5,799,960, the entire disclosures of which are hereby incorporated by reference. The bore fluid is preferably water, but a mixture of water and an organic solvent (for example NMP) may be used as well. The precursor solution (known as a spin dope in the case of hollow fiber spinning) is fed through an outer annular channel of the spinneret so that it surrounds the bore fluid to form a nascent polymeric hollow fiber.

The diameter of the eventual solid polymeric precursor fiber is partly a function of the size of the hollow fiber spinnerets. The outside diameter of the spinneret can be from about 400 μm to about 2000 μm, with bore solution capillary-pin outside diameter from 200 μm to 1000 μm. The inside diameter of the bore solution capillary is determined by the manufacturing limits for the specific outside diameter of the pin.

The temperature of the solution during delivery to the spinneret and during spinning of the hollow fiber depends on various factors including the desired viscosity of the dispersion within the spinneret and the desired fiber properties. At higher temperature, viscosity of the dispersion will be lower, which may facilitate extrusion. At higher spinneret temperature, solvent evaporation from the surface of the nascent fiber will be higher, which will impact the degree of asymmetry or anisotropy of the fiber wall. In general, the temperature is adjusted to maintain the desired viscosity of the dispersion and the fiber wall asymmetry. Typically, the temperature is from about 20° C. to about 100° C., preferably from about 20° C. to about 60° C.

Upon extrusion from the spinneret, the nascent polymeric hollow fiber is passed through an air gap and immersed in a suitable liquid coagulant bath to facilitate phase inversion of the dissolved polyimide and solidification of the precursor fiber structure. The coagulant constitutes a non-solvent or a poor solvent for the polymer while at the same time a good solvent for the solvent within the dispersion. As a result, the solvent for the polymer is extracted from the nascent fiber causing the polymer to solidify as it is drawn through the quench bath. Suitable liquid coagulants include water (with or without a water-soluble salt) and/or alcohol with or without other organic solvents. Typically, the liquid coagulant is water.

The solidified fiber is then withdrawn from the coagulant and wound onto a rotating take-up roll, drum, spool, bobbin or other suitable conventional collection device. Before or after collection, the fiber may optionally be washed to remove any residual solvent. After collection, the fiber may optionally be dried to remove any remaining volatile material.

Other exemplary conventional processes for producing polymeric hollow fibers are disclosed in U.S. Pat. No. 5,015,270, U.S. Pat. No. 5,102,600, and Clausi, et al., (Formation of Defect-free Polyimide, Hollow Fiber Membranes for Gas Separations, Journal of Membrane Science, 167 (2000) 79-89), the entire disclosures of which are hereby incorporated by reference herein.

The completed precursor fibers have an outer diameter that typically ranges from about 150-550 μm (optionally 200-300 μm) and an inner diameter that typically ranges from 75-275 μm (optionally 100-150 μm). In some cases unusually thin walls (for example, thicknesses less than 30 μm) may be desirable to maximize productivity while maintaining desirable durability.

Once the precursor has been formed into the desired configuration (such as, for example a dense film or hollow fibers), the precursor membrane is at least partially, and optionally fully, pyrolyzed to form the final CMS membrane.

Polymeric films or fibers may then be pyrolyzed to produce CMS membranes.

In the case of polymeric films, the films are typically placed on a quartz plate, which is optionally ridged to allow for the diffusion of volatile by-products from the top and bottom of the films into the effluent stream. The quartz plate and films may then be loaded into a pyrolysis chamber.

In the case of polymeric fibers, the fibers are typically placed on the quartz plate and/or a piece of stainless steel mesh and held in place by any conventional means, e.g., by wrapping a length of bus wire around the mesh and fibers. The mesh support and fibers may then be loaded into the pyrolysis chamber. Alternatively, the fibers may be secured on one of both ends by any suitable means and placed vertically in a pyrolysis chamber.

The pyrolysis may be carried out under vacuum or in an atmosphere consisting of an inert gas, optionally having a relatively low oxygen level.

For vacuum pyrolysis, the pressure of the ambient surrounding the membrane is maintained at a pressure typically ranging from about 0.01 mm Hg to about 0.10 mm Hg or even as low as 0.05 mm Hg or lower.

While any inert gas in the field of polymeric pyrolysis may be utilized as a purge gas during pyrolysis, suitable inert gases include argon, nitrogen, helium, and mixtures thereof. Typical optional low-oxygen inert gas atmosphere pyrolysis methods are disclosed in US 2011/0100211. Typically, the ambient atmosphere surrounding the CMS membrane is purged with an inert gas having a relatively low oxygen concentration. By selecting a particular oxygen concentration (i.e., through selection of an appropriate low-oxygen inert purge gas) or by controlling the oxygen concentration of the pyrolysis atmosphere, the gas separation performance properties of the resulting CMS membrane may be controlled or tuned. The ambient atmosphere surrounding the CMS membrane may be purged with an amount of inert purge gas sufficient to achieve the desired oxygen concentration or the pyrolysis chamber may instead be continuously purged. While the oxygen concentration, either of the ambient atmosphere surrounding the CMS membrane in the pyrolysis chamber or in the inert gas gas is less than about 50 ppm, it is typically less than 40 ppm or even as low as about 8 ppm, 7 ppm, or 4 ppm.

While the pyrolysis temperature may range from 500-1,000° C., typically it is between about 450-800° C. As two particular examples, the pyrolysis temperature may be 1,000° C. or more or it may be maintained between about 500-550° C. The pyrolysis includes at least one ramp step whereby the temperature is raised over a period of time from an initial temperature to a predetermined temperature at which the polymer is pyrolyzed and carbonized. The ramp rate may be constant or follow a curve. The pyrolysis may optionally include one or more pyrolysis soak steps (i.e., the pyrolysis temperature may be maintained at a particular level for a set period of time) in which case the soak period is typically between about 1-10 hours or optionally from about 2-8 or 4-6 hours.

An illustrative heating protocol may include starting at a first set point (i.e., the initial temperature) of about 50° C., then heating to a second set point of about 250° C. at a rate of about 3.3° C. per minute, then heating to a third set point of about 535° C. at a rate of about 3.85° C. per minute, and then a fourth set point of about 550° C. at a rate of about 0.25 degrees centigrade per minute. The fourth set point is then optionally maintained for the determined soak time. After the heating cycle is complete, the system is typically allowed to cool while still under vacuum or in the controlled atmosphere provided by purging with the low oxygen inert purge gas.

Another illustrative heating protocol (for final temperatures up to 550° C. has the following sequence: 1) ramp rate of 13.3° C./min from 50° C. to 250° C.; 2) ramp rate of 3.85° C./min from 250° C. to 15° C. below the final temperature (Tₘₐₓ); 3) ramp rate of 0.25° C./min from Tₘₐₓ-15° C. to Tₘₐₓ; 4) soak for 2 h at Tₘₐₓ.

Yet another illustrative heating protocol (for final temperatures of greater than 550° C. and no more than 800° C. has the following sequence: 1) ramp rate of 13.3° C./min from 50° C. to 250° C.; 2) ramp rate of 0.25° C./min from 250° C. to 535° C.; 3) ramp rate of 3.85° C./min from 535° C. to 550° C.; 4) ramp rate of 3.85° C./min from 550° C. to 15° C. below the final temperature Tₘₐₓ; 5) ramp rate of 0.25° C./min from 15° C. below the final temperature Tₘₐₓ to Tₘₐₓ; 6) soak for 2 h at Tₘₐₓ.

Still another heating protocol is disclosed by U.S. Pat. No. 6,565,631. Its disclosure is incorporated herein by reference.

After the heating protocol is complete, the membrane is allowed to cool in place to at least 40° C. while still under vacuum or in the inert gas environment.

While any known device for pyrolyzing the membrane may be used, typically, the pyrolysis equipment includes a quartz tube within a furnace whose temperature is controlled with a temperature controller.

In case the pyrolysis is carried out under a vacuum, the ends of the quartz tube to seal the tube to reduce any leaks. In vacuum pyrolysis, a vacuum pump is used in conjunction with a liquid nitrogen trap to prevent any back diffusion of oil vapor from the pump and also a pressure transducer for monitoring the level of vacuum within the quartz tube.

While the source of inert gas may already have been doped with oxygen to achieve a predetermined oxygen concentration, an oxygen-containing gas such as air or pure oxygen may be added to a line extending between the source of inert gas and the furnace via a valve such as a micro needle valve. In this manner, the oxygen-containing gas can be added directly to the flow of inert gas to the quartz tube. The flow rate of the gas may be controlled with a mass flow controller and optionally confirmed with a bubble flow meter before and after each pyrolysis process. Any oxygen analyzer suitable for measuring relatively low oxygen concentrations may be integrated with the system to monitor the oxygen concentration in the quartz tube and/or the furnace during the pyrolysis process.

Between pyrolysis processes, the quartz tube and plate may optionally be rinsed with acetone and baked in air at 800° C. to remove any deposited materials which could affect consecutive pyrolyses.

Following the pyrolysis step and allowing for any sufficient cooling, the CMS membranes may be loaded or assembled into any convenient type of separation unit. For example, flat-sheet membranes can be stacked in plate-and-frame modules or wound in spiral-wound modules. Spiral wound modules are made by winding several folded flat sheets around a central permeate tube and sealing the exposed edges with an epoxy or polyurethane adhesive. Plate and frame modules use gaskets to seal membrane sheets between feed-and permeate-side spacer plates. Hollow-fiber membranes are typically potted with a thermoset resin in cylindrical housings. The final membrane separation unit can comprise one or more membrane modules. These can be housed individually in pressure vessels or multiple modules can be mounted together in a common housing of appropriate diameter and length.

If CMS fibers are used, a suitable plurality of bundled pyrolyzed fibers forms a separation unit. The number of fibers bundled together will depend on fiber diameters, lengths, and on desired throughput, equipment costs, and other engineering considerations understood by those of ordinary skill in the art. The fibers may be held together by any means known in the field. This assembly is typically disposed inside a pressure vessel such that one end of the fiber assembly extends to one end of the pressure vessel and the opposite end of the fiber assembly extends to the opposite end of the pressure vessel. The fiber assembly is then fixably or removably affixed to the pressure vessel by any conventional method (e.g., tubesheet(s)) to form a pressure tight seal.

For industrial use, a permeation cell or module made using either pyrolyzed film or fibers may be operated, as described in U.S. Pat. No. 6,565,631, e.g., as a shell-tube heat exchanger, where the feed is passed to either the shell or tube side at one end of the assembly and the product is removed from the other end. For maximizing high pressure performance, the feed is advantageously fed to the shell side of the assembly at a pressure of greater than about 10 bar, and alternatively at a pressure of greater than about 40 bar. The feed may be any gas having a component to be separated, such as a natural gas feed containing an acid gas such as CO₂ or air or a mixture of an olefin and paraffin.

The described preparation of CMS membranes leads to an almost pure carbon material. Such materials are believed to have a highly aromatic structure comprising disordered sp² hybridized carbon sheet, a so-called “turbostratic” structure. The structure can be envisioned to comprise roughly parallel layers of condensed hexagonal rings with no long range three-dimensional crystalline order. Pores are formed from packing imperfections between microcrystalline regions in the material and their structure in CMS membranes is known to be slit-like. The CMS membrane typically exhibits a bimodal pore size distribution of micropores and ultramicropore—a morphology which is known to be responsible for the molecular sieving gas separation process.

The micropores are believed to provide adsorption sites, and ultramicropores are believed to act as molecular sieve sites. The ultramicropores are believed to be created at “kinks” in the carbon sheet, or from the edge of a carbon sheet. These sites have more reactive unpaired sigma electrons prone to oxidation than other sites in the membrane. Based on this fact, it is believed that by tuning the amount of oxygen exposure, the size of selective pore windows can be tuned. It is also believed that tuning oxygen exposure results in oxygen chemisorption process on the edge of the selective pore windows. US 2011/0100211 discloses typical conditions for tuning the amount of oxygen exposure. The pyrolysis temperature can also be tuned in conjunction with tuning the amount of oxygen exposure. It is believed that lowering pyrolysis temperature produces a more open CMS structure. This can, therefore, make the doping process more effective in terms of increasing selectivity for challenging gas separations for intrinsically permeable polymer precursors. Therefore, by controlling the pyrolysis temperature and the concentration of oxygen one can tune oxygen doping and, therefore, gas separation performance. In general, more oxygen and higher temperature leads to smaller pores. Higher temperatures generally cause the formation of smaller micro and ultramicropores, while more oxygen generally causes the formation of small selective ultramicropores without having a significant impact on the larger micropores into which gases are absorbed.

The benefits of zeolite enhanced CMS membrane in gas separation are: (1) better selectivity through selecting an appropriate zeolite crystal material, adjusting the percentage of zeolite in the matrix and controlling polymer pyrolysis conditions; (2) increased gas permeability caused by increased adsorption capacity of permeable molecules on the zeolite material; and (3) increased membrane applicability in gas separation applications with different type of zeolite.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method for producing a zeolite enhanced carbon molecular sieve (CMS) membrane, comprising the steps of forming a precursor membrane from a matrix of polymer and zeolite particles, and pyrolyzing the precursor membrane under conditions sufficient to form a CMS membrane.

2. The method of claim 1, wherein the precursor membrane and CMS membrane are configured as a plurality of hollow fibers.

3. The method of claim 1, further comprising the step of purging the ambient atmosphere of the precursor membrane being pyrolyzed with an inert gas.

4. The method of claim 3, wherein the inert gas is argon, nitrogen, or helium.

5. The method of claim 1, further comprising the step of subjecting the precursor membrane during pyrolysis to vacuum.

6. The method of claim 5, wherein the precursor membrane is subjected to a vacuum of about 0.01 mm Hg to about 0.10 mm Hg.

7. The method of claim 5, wherein the precursor membrane is subjected to a vacuum of about 0.05 mm Hg or lower.

8. The method of claim 1, wherein the polymer is selected from the group consisting of polyimides, polyamides, polyimide amides, polyacrylonitrile, phenolic resin, polyfurfuryl alcohol, polyvinylidene chloride-acrylate terpolymer, phenol formaldehyde, and cellulose acetate.

9. The zeolite enhanced CMS membrane formed by the method of claim 1.
